(19) United States
(12) Patent Application Publication
(10) Pub. No.: US 2022/0171066 A1
(43) Pub. Date: Jun. 2, 2022

(54) SYSTEMS AND METHODS FOR JOINTLY PREDICTING TRAJECTORIES OF MULTIPLE MOVING OBJECTS

(71) Applicant: BEIJING VOYAGER TECHNOLOGY CO., LTD., Beijing (CN)

(72) Inventors: Pei LI, Beijing (CN); Jian GUAN, Beijing (CN); You LI, Beijing (CN)

(73) Assignee: BEIJING VOYAGER TECHNOLOGY CO., LTD., Beijing (CN)

(21) Appl. No.: 17/674,801

(22) Filed: Feb. 17, 2022

Related U.S. Application Data
(63) Continuation of application No. PCT/CN2019/109351, filed on Sep. 30, 2019.

(51) Int. Cl. G01S 17/89; G01S 17/66; G01S 17/931; G01S 7/4865; G06N 20/00

(52) U.S. Cl. CPC G01S 17/89; G01S 17/66; G06N 20/00; G01S 7/4865; G01S 17/931

(57) ABSTRACT

Embodiments of the disclosure provide methods and systems for jointly predicting movement trajectories of a plurality of moving objects. The system includes a communication interface configured to receive a map of an area in which the plurality of moving objects are traveling and sensor data acquired associated with the plurality of moving objects. The system further includes at least one processor configured to position the plurality of moving objects in the map. The at least one processor further determines object features of each moving object based on the sensor data, and determines regulation features of the moving objects. The object features characterize movement of the respective moving object, and the regulation features characterize traffic regulations the moving objects need to obey. The at least one processor also jointly predicts the movement trajectories of the plurality of moving objects based on the object features and regulation features using a learning model.

### CROSS REFERENCE TO RELATED APPLICATIONS

This application is a bypass continuation to PCT Application No. PCT/CN2019/109351, filed Sep. 30, 2019. The present application is also related to PCT Application Nos. PCT/CN2019/109350, PCT/CN2019/109352, and PCT/CN2019/109354, each filed Sep. 30, 2019. The entire contents of all of the above-identified applications are incorporated herein by reference in their entireties.

### TECHNICAL FIELD

The present disclosure relates to systems and methods for predicting moving object trajectories, and more particularly, to systems and methods for jointly predicting trajectories of multiple moving objects based on machine learning.

### BACKGROUND

Vehicles share roads with other vehicles, bicycles, pedestrians, and objects, such as traffic signs, road blocks, fences, etc. Therefore, drivers need to constantly adjust driving to avoid colliding the vehicle with such obstacles. While some obstacles are generally static and therefore easy to avoid, some others might be moving. For a moving obstacle, the driver has to not only observe its current position but to predict its moving trajectory in order to determine its future positions. For example, a pedestrian near the vehicle may go across the road in front of the vehicle, go in a direction parallel to the vehicle's driving direction, or make a stop. The driver typically makes the prediction based on observations such as the pedestrian's traveling speed, the direction the pedestrian is facing, and any hand signals the pedestrian provides, etc.

When multiple moving objects present in a locality, the movements of the objects may be further impacted by each other. For example, when vehicles, bicycles, and pedestrians are at the same cross-road, their moving trajectories are further impacted by who has the right-of-way at the time. Accordingly, a driver near multiple moving objects will need to account for not only the status information of each individual moving object, but also the possible interactions of these objects, when predicting their moving trajectories.

Automatous driving vehicles need to make similar decisions to avoid obstacles. Therefore, automatous driving technology relies heavily on automated prediction of the trajectories of other moving obstacles. However, existing prediction systems and methods are limited by the vehicle's ability to “see” (e.g., to collect relevant data), ability to process the data, and ability to make accurate predictions based on the data. Predicting trajectories of multiple moving objects present nearby at the same time is particularly challenging. Accordingly, automatous driving vehicles can benefit from improvements to the existing prediction systems and methods.

Embodiments of the disclosure improve the existing prediction systems and methods in automatous driving by providing systems and methods for jointly predicting movement trajectories of multiple moving objects using object features and regulation features extracted from map and sensor data.

### SUMMARY

Embodiments of the disclosure provide a system for jointly predicting movement trajectories of a plurality of moving objects. The system includes a communication interface configured to receive a map of an area in which the plurality of moving objects are traveling and sensor data acquired associated with the plurality of moving objects. The system further includes at least one processor configured to position the plurality of moving objects in the map. The at least one processor is further configured to determine object features of each moving object based on the sensor data, and determine regulation features of the moving objects. The object features characterize movement of the respective moving object, and the regulation features characterize traffic regulations the moving objects need to obey. The at least one processor is also configured to jointly predict the movement trajectories of the plurality of moving objects based on the object features and regulation features using a learning model.

Embodiments of the disclosure also provide a method for jointly predicting movement trajectories of a plurality of moving objects. The method includes receiving, through a communication interface, a map of an area in which the plurality of moving objects are traveling and sensor data acquired associated with the plurality of moving objects. The method further includes positioning, by at least one processor, the plurality of moving objects in the map. The method also includes determining object features of each moving object based on the sensor data, and determining regulation features of the moving objects, by the at least one processor. The object features characterize movement of the respective moving object, and the regulation features characterize traffic regulations the moving objects need to obey. The method additionally includes jointly predicting, by the at least one processor, the movement trajectories of the plurality of moving objects based on the object features and regulation features using a learning model.

Embodiments of the disclosure further provide a non-transitory computer-readable medium having instructions stored thereon that, when executed by at least one processor, causes the at least one processor to perform operations. The operations include receiving a map of an area in which a plurality of moving objects are traveling and sensor data acquired associated with the plurality of moving objects. The operations further include positioning the plurality of moving objects in the map. The operations also include determining object features of each moving object based on the sensor data, and determining regulation features of the moving objects. The object features characterize movement of the respective moving object, and the regulation features characterize traffic regulations the moving objects need to obey. The operations additionally include jointly predicting movement trajectories of the plurality of moving objects based on the object features and regulation features using a learning model.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary cross-road including multiple moving objects, according to embodiments of the disclosure.

FIG. 2A illustrates a schematic diagram of an exemplary system for jointly predicting trajectories of multiple moving objects, according to embodiments of the disclosure.

FIG. 2B illustrates exemplary candidate trajectories of multiple moving objects, according to embodiments of the disclosure.

FIG. 3 illustrates an exemplary vehicle with sensors equipped thereon, according to embodiments of the disclosure.

FIG. 4 is a block diagram of an exemplary server for jointly predicting trajectories of multiple moving objects, according to embodiments of the disclosure.

FIG. 5 is a flowchart of an exemplary method for jointly predicting trajectories of multiple moving objects, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

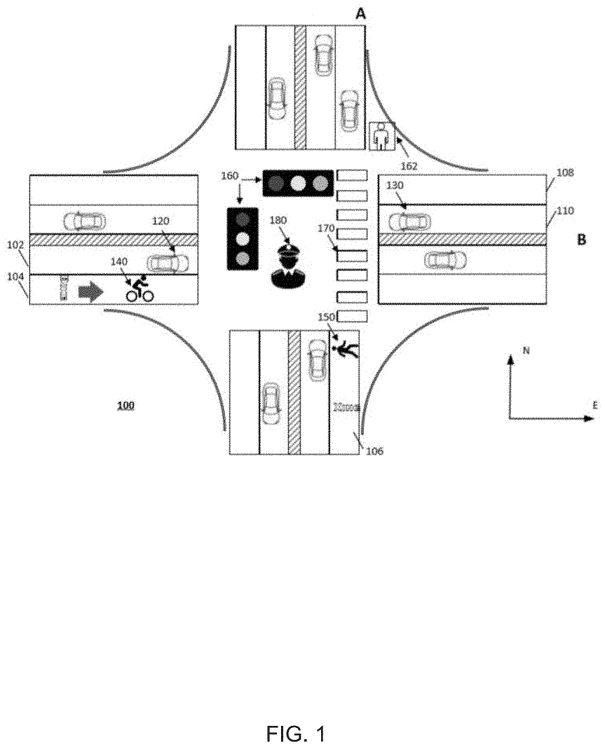

FIG. 1 illustrates a schematic diagram of an exemplary cross-road 100 including multiple moving objects (e.g., vehicles 120 and 130, bicycle 140, and pedestrian 150), according to embodiments of the disclosure. As shown in FIG. 1, cross-road 100 includes two roads, one is shown in the vertical direction (referred to as “road A”) and another is shown in the horizontal direction (referred to as “road B”), crossing each other, and traffic lights 160 and 162 at the crossing. For ease of description, road A is illustrated to extend in the North-South direction, and road B is illustrated to extend in the East-West direction. It is contemplated that roads A and B can extend in any other directions, and are not necessarily perpendicular to each other.

Each of road A and road B is shown as a two-way road. For example, road B includes first direction lanes 102 and 104 and second direction lanes 108 and 110. The first and second directions may be opposite to each other and separated by a divider. It is contemplated that one or both of the roads may be one-way and/or have more or less lanes.

Various vehicles may be traveling on the roads in both directions. For example, vehicle 120 may be traveling east-bound on first direction lane 102, and vehicle 130 may be traveling west-bound on second direction lane 103. In some embodiments, vehicles 120 and 130 may be electric vehicles, fuel cell vehicles, hybrid vehicles, or conventional internal combustion engine vehicles. In some embodiments, vehicle 120 may be an autonomous or semi-autonomous vehicle.

Various bicycles may be traveling on cross-road 100, such as on lane 104, as shown in FIG. 1. For example, bicycle 140, ridden by a cyclist, may be traveling east-bound on lane 104. Consistent with the present disclosure, a “bicycle” may be a mechanical bike, an electric bike, a scooter, a hoverboard, a Segway™, or any transportation tool that is not a motorized vehicle. In some embodiments, lane 104 may be marked with a lane marking to indicate it is a bike lane. In some embodiments, the bicycles may share lane 104 with vehicles. In some other embodiments, lane 104 may be a dedicated bike lane separated from the vehicle lane (e.g., lane 102). For example, the bike lane may be separated from vehicle lanes by a line marking, a guardrail, a fence, a plant strip, or a no-entry zone. In some embodiments, the words “bike lane” may be marked, and/or a directional arrow pointing to the intended traffic direction are marked on the bike lane, as shown in FIG. 1. In another example, a bicycle icon alternative or in additional to the words may be marked on the bike lane.

In addition, pedestrians may be traveling at cross-road 100. For example, pedestrian 150 may be traveling north-bound on lane 106. In some embodiments, pedestrians may share lane 106 with vehicles and/or bicycles. In some other embodiments, lane 106 may be a dedicated sidewalk for pedestrians separated from the vehicle lane. For example, the sidewalk may be separated from vehicle lanes by a line marking, a guardrail, a fence, a plant strip, or a no-entry zone. In some embodiments, the sidewalk may be marked with a lane marking, such as the word “Xing,” as shown in FIG. 1. In another example, a pedestrian icon alternative or in additional to the words may be marked on the sidewalk.

In some embodiments, pedestrian 150 may cross the road on a crosswalk 170. In some embodiments, crosswalk 170 may be marked using white strips on the road surface (known as zebra lines). The traffic direction of a crosswalk extends perpendicularly to the strips. For example, crosswalk 170 contains strips extending east-west direction and pedestrian 150 walks north-bound or south-bound on crosswalk 170 to cross the road. A pedestrian walking on a crosswalk has the right-of-way and other traffics will stop and yield to the pedestrian until he has crossed. Although FIG. 1 shows only one crosswalk 170, it is contemplated that there may be additional crosswalks extending different directions. It is also contemplated that crosswalk 170 is not necessary located at a cross-road with traffic lights. In some embodiments, crosswalks may present in the middle of a road segment.

It is contemplated that bicycle 140 and pedestrian 150 may routinely cross at places that are not regulated by traffic lights and/or have no crosswalk. For example, bicycle 140 and/or pedestrian 150 may turn left in order to enter a trail on the left hand of the road. In that case, the cyclist may typically make a hand signal to the vehicles before getting into a vehicle lane. For example, the cyclist may point his left arm to the left to signal a left-turn; raise his left arm up or point his right arm to the right to signal a right-turn, or point his left arm down or put his right hand behind his waist to signal he plans to make a stop. Similarly, the pedestrian may sometimes make a hand signal to the vehicles before getting into a vehicle lane. For example, the pedestrian may raise his palm to signal the vehicles to stop or point to the direction he intends to walk.

Traffic of vehicles, bicycles, and pedestrians at cross-road 100 may be regulated by traffic light 160 and pedestrian traffic lights 162. For example, traffic light 160 may regulate the vehicle traffic and pedestrian traffic lights 162 may regulate the bicycle and pedestrian traffic. In some embodiments, traffic light 160 may include lights in three colors: red, yellow and green, to signal the right-of-way at the cross-road. In some embodiments, traffic light 160 may additionally include turn protection lights to regulate the left, right, and/or U-turns. For example, a left turn protection light may allow vehicles in certain lanes (usually the left-most lane) to turn left without having to yield to vehicles traveling straight in the opposite direction.

Pedestrian traffic light 162 may switch between two modes: a “walk” mode and “do not walk” mode. Depending on the design, the pedestrian traffic light may show different words or icons to indicate the modes. For example, the pedestrian traffic light may show a pedestrian icon when pedestrians and bicycles are allowed to cross, and a hand icon to stop the same traffic. In some embodiments, pedestrian traffic lights 162 may additionally use different colors, sounds (e.g., beeping sounds), and/or flashing to indicate the modes. For example, the “walk” mode may be displayed in green and the “do not walk” mode may be displayed in red.

In some embodiments, traffic at cross-road 100 may be further regulated by officer 180. Officer 180 may direct traffic using hand gestures, under special circumstances, such as malfunction of the traffic lights, road constructions, or accidents on the road that cause severe traffic jams. Officer 180's regulation may overwrite other regulations.

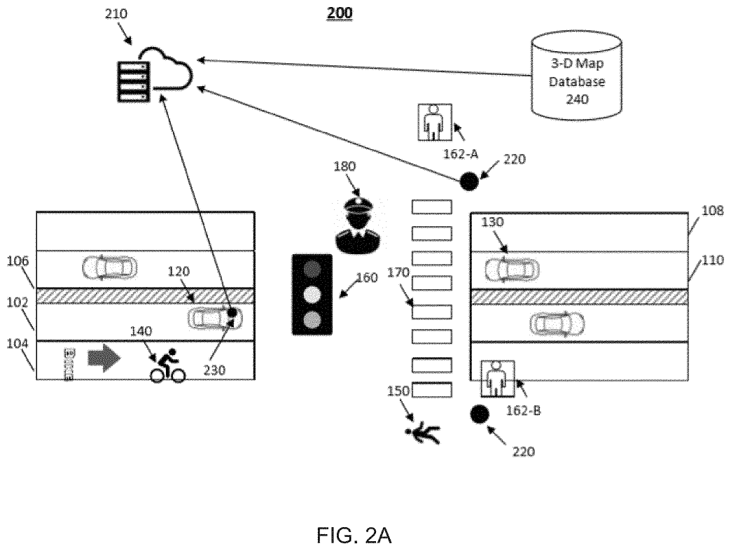

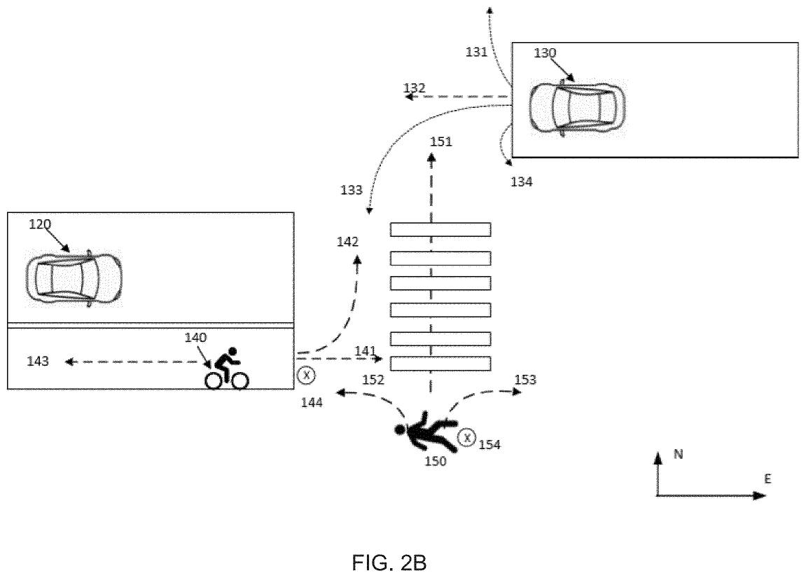

In some embodiments, vehicle 120 may be equipped with or in communication with a trajectory prediction system (e.g., system 200 shown in FIG. 2A) to jointly predict the trajectories of the other moving objects on the road, such as vehicle 130, bicycle 140, and pedestrian 150. While jointly predicting these trajectories, vehicle 120 considers the moving characteristics of the respective objects (“object features”) and regulations that the objects collectively have to comply with (“regulation features”). Based on the predicted trajectories of these objects, vehicle 120 then makes autonomous control decisions to avoid these objects in its own travel path.

For example, as shown in FIG. 2B, vehicle 130 may possibly travel in four candidate trajectories: a candidate trajectory 131 to make a right-turn, a candidate trajectory 132 to go straight, a candidate trajectory 133 to make a left-turn, and a candidate trajectory 134 to make a U-turn. Bicycle 140 traveling east-bound may possibly follow four candidate trajectories: a candidate trajectory 141 to go straight, a candidate trajectory 142 to turn left, a candidate trajectory 143 to turn around and travel west-bound, and a candidate trajectory 144 to make a stop. Pedestrian 150 facing north may possibly follow four candidate trajectories: a candidate trajectory 151 to cross the road north-bound, a candidate trajectory 152 to turn left and go west-bound, a candidate trajectory 153 to turn right and go east-bound, and a candidate trajectory 154 to make a stop. It is contemplated that these illustrated candidate trajectories in FIG. 2B are only exemplary.

Consistent with embodiments of the present disclosure, the trajectory prediction system may make “observations” (e.g., through various sensors) of the moving objects, such as vehicle 130 and bicycle 140, and pedestrian 150, and surrounding regulatory objects, such as traffic light(s) 160, pedestrian traffic light(s) 162, crosswalk 170, officer 180, and traffic signs at cross-road 100, etc. The trajectory prediction system then makes a prediction which candidate trajectory vehicle 130 may likely follow based on these observations. In some embodiments, the prediction may be performed using a learning model, such as a neural network. In some embodiments, probabilities may be determined for the respective candidate trajectories 151-154.

Consistent with embodiments of the present disclosure, the trajectory prediction system may make “observations” (e.g., through various sensors) of moving objects and the surrounding regulatory objects. Based on the type of moving objects detected on cross-road 100 and status of regulatory objects, the trajectory prediction system may further retrieve or determine regulation rules that govern the movement of these moving objects on cross-road 100. For example, vehicles need to yield pedestrians and pedestrians on crosswalk 170, and all moving objects need to obey the regulation of officer 180. The trajectory prediction system then makes a joint prediction of candidate trajectories the moving objects may likely follow respectively based on these observations. In some embodiments, the prediction may be performed using a learning model, such as a neural network. In some embodiments, scores (e.g., probabilities and rankings) may be determined for the respective combinations of candidate trajectories 131-134, 141-144, and 151-154.

FIG. 2A illustrates a schematic diagram of an exemplary system 200 for jointly predicting trajectories of multiple moving objects, according to embodiments of the disclosure. In some embodiments, system 200 may include a trajectory prediction server 210 (also referred to as server 210 for simplicity). Server 210 can be a general-purpose server configured or programmed to jointly predict movement trajectories of multiple moving objects or a proprietary device specially designed for predicting movement trajectories of various objects on the road. It is contemplated that server 210 can be a stand-alone server or an integrated component of a stand-alone server. In some embodiments, server 210 may be integrated into a system onboard a vehicle, such as vehicle 120.

As illustrated in FIG. 2A, server 210 may receive and analyze data collected by various sources. For example, data may be continuously, regularly, or intermittently captured by sensors 220 (e.g., including sensors 220) equipped along a road and/or one or more sensors 230 equipped on vehicle 120 driving through lane 102. Sensors 220 and 230 may include radars, LiDARs, cameras (such as surveillance cameras, monocular/binocular cameras, video cameras), speedometers, or any other suitable sensors to capture data characterizing the moving objects, such as vehicle 130, bicycle 140, and pedestrian 150, and regulatory objects surrounding the moving objects, such as traffic light 160, pedestrian traffic lights 162, crosswalk 170, and officer 180. For example, sensors 220 may include one or more surveillance cameras that capture images of these objects.

In some embodiments, sensors 230 may include a LiDAR that measures a distance between vehicle 120 and a moving object, and determines the position of pedestrian 150 in a 3-D map. In some embodiments, sensor 230 may also include a GPS/IMU (inertial measurement unit) sensor to capture position/pose data of vehicle 120. In some embodiments, sensors 230 may additionally include cameras to capture images of moving objects and surrounding regulatory objects. Since the images captured by sensors 220 and sensors 230 are from different angles, they may supplement each other to provide more detailed information of the moving objects and surrounding regulatory objects. In some embodiments, sensors 220 and 230 may acquire data that tracks the trajectories of moving objects, such as vehicles, bicycles, pedestrians, etc.

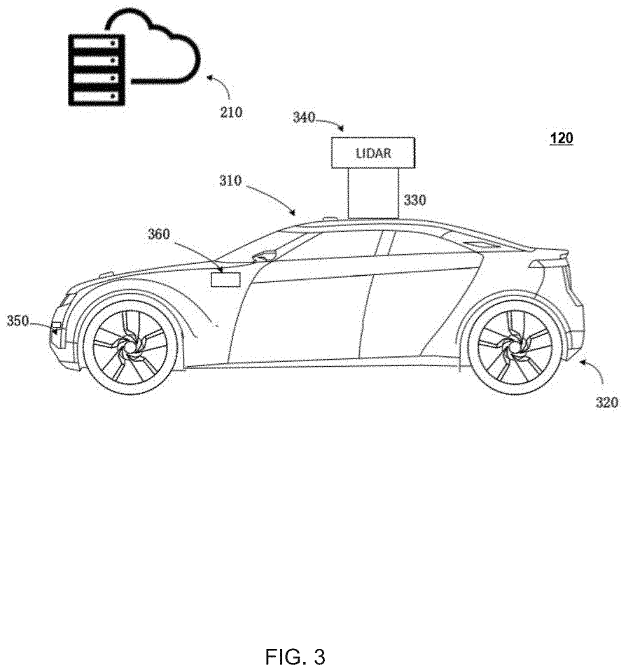

In some embodiments, sensors 230 may be equipped on vehicle 120 and thus travel with vehicle 120. For example, FIG. 3 illustrates an exemplary vehicle 120 with sensors 340-360 equipped thereon, according to embodiments of the disclosure. Vehicle 120 may have a body 310, which may be any body style, such as a sports vehicle, a coupe, a sedan, a pick-up truck, a station wagon, a sports utility vehicle (SUV), a minivan, or a conversion van. In some embodiments, vehicle 120 may include a pair of front wheels and a pair of rear wheels 320, as illustrated in FIG. 3. However, it is contemplated that vehicle 120 may have less wheels or equivalent structures that enable vehicle 120 to move around. Vehicle 120 may be configured to be all wheel drive (AWD), front wheel drive (FWR), or rear wheel drive (RWD). In some embodiments, vehicle 120 may be configured to be an autonomous or semi-autonomous vehicle.

As illustrated in FIG. 3, sensors 230 of FIG. 2 may include various kinds of sensors 340, 350, and 360, according to embodiments of the disclosure. Sensor 340 may be mounted to body 310 via a mounting structure 330. Mounting structure 330 may be an electro-mechanical device installed or otherwise attached to body 310 of vehicle 120. In some embodiments, mounting structure 330 may use screws, adhesives, or another mounting mechanism. Vehicle 120 may be additionally equipped with sensors 350 and 360 inside or outside body 310 using any suitable mounting mechanisms. It is contemplated that the manners in which sensors 340-360 can be equipped on vehicle 120 are not limited by the example shown in FIG. 3 and may be modified depending on the types of sensors 340-360 and/or vehicle 120 to achieve desirable sensing performance.

Consistent with some embodiments, sensor 340 may be a LiDAR that measures the distance to a target by illuminating the target with pulsed laser lights and measuring the reflected pulses. Differences in laser return times and wavelengths can then be used to make digital 3-D representations of the target. For example, sensor 340 may measure the distance between vehicle 120 and another object. The light used for LiDAR scan may be ultraviolet, visible, or near infrared. Because a narrow laser beam can map physical features with a very high resolution, a LiDAR scanner is particularly suitable for positioning objects in a 3-D map. For example, a LiDAR scanner may capture point cloud data, which may be used to position vehicle 120 and/or other objects.

In some embodiments, sensors 350 may include one or more cameras mounted on body 310 of vehicle 120. Although FIG. 3 shows sensors 350 as being mounted at the front of vehicle 120, it is contemplated that sensors 350 may be mounted or installed at other positions of vehicle 120, such as on the sides, behind the mirrors, on the windshields, on the racks, or at the rear end. Sensors 350 may be configured to capture images of objects near vehicle 120, such as vehicle 130, bicycle 140, and pedestrian 150 on the roads, traffic lights (e.g., 140 and 142), crosswalk 170, officer 180, and/or traffic signs. In some embodiments, the cameras may be monocular or binocular cameras. The binocular cameras may acquire data indicating depths of the objects (i.e., the distances of the objects from the cameras). In some embodiments, the cameras may be video cameras that capture image frames over time, thus recording the movements of the objects.

As illustrated in FIG. 3, vehicle 120 may be additionally equipped with sensor 360, which may include sensors used in a navigation unit, such as a GPS receiver and one or more IMU sensors. A GPS is a global navigation satellite system that provides geolocation and time information to a GPS receiver. An IMU is an electronic device that measures and provides a vehicle's specific force, angular rate, and sometimes the magnetic field surrounding the vehicle, using various inertial sensors, such as accelerometers and gyroscopes, sometimes also magnetometers. By combining the GPS receiver and the IMU sensor, sensor 360 can provide real-time pose information of vehicle 120 as it travels, including the positions and orientations (e.g., Euler angles) of vehicle 120 at each time point.

Consistent with the present disclosure, sensors 340-360 may communicate with server 210 via a network to transmit the sensor data continuously, or regularly, or intermittently. In some embodiments, any suitable network may be used for the communication, such as a Wireless Local Area Network (WLAN), a Wide Area Network (WAN), wireless communication networks using radio waves, a cellular network, a satellite communication network, and/or a local or short-range wireless network (e.g., Bluetooth™).

Referring back to FIG. 2A, system 200 may further include a 3-D map database 240. 3-D map database 240 may store 3-D maps. The 3-D maps may include maps that cover different regions and areas. For example, a 3-D map (or map portion) may cover the area of cross-road 100. In some embodiments, server 210 may communicate with 3-D map database 240 to retrieve a relevant 3-D map (or map portion) based on the position of vehicle 120. For example, map data containing the GPS position of vehicle 120 and its surrounding area may be retrieved. In some embodiments, 3-D map database 240 may be an internal component of server 210. For example, the 3-D maps may be stored in a storage of server 210. In some embodiments, 3-D map database 240 may be external of server 210 and the communication between 3-D map database 240 and server 210 may occur via a network, such as the various kinds of networks described above.

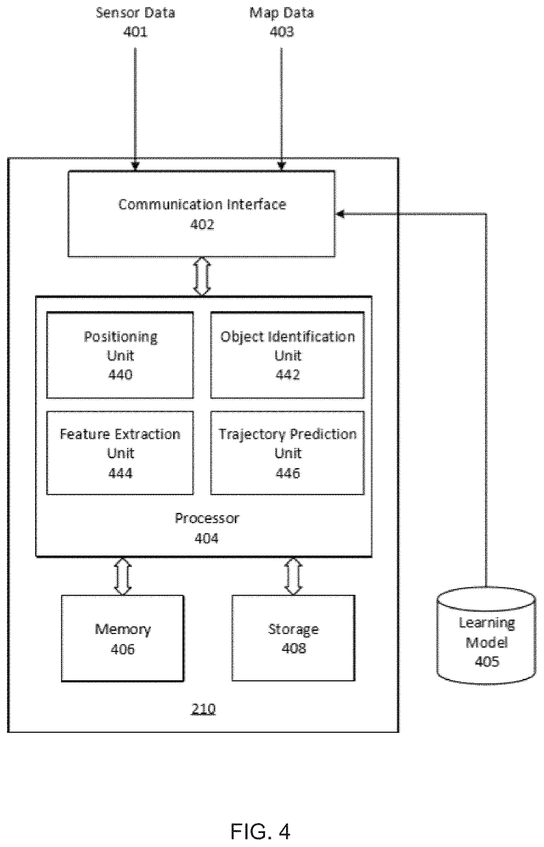

Server 210 may be configured to analyze the sensor data received from sensors 230 (e.g., sensors 340-360) and the map data received from 3-D map database 240 to predict the trajectories of the moving objects, such as vehicle 130, bicycle 140, and pedestrian 150. FIG. 4 is a block diagram of an exemplary server 210 for jointly predicting movement trajectories of multiple moving objects, according to embodiments of the disclosure. Server 210 may include a communication interface 402, a processor 404, a memory 406, and a storage 408. In some embodiments, server 210 may have different modules in a single device, such as an integrated circuit (IC) chip (implemented as an application-specific integrated circuit (ASIC) or a field-programmable gate array (FPGA)), or separate devices with dedicated functions. Components of server 210 may be in an integrated device, or distributed at different locations but communicate with each other through a network (not shown).

Communication interface 402 may send data to and receive data from components such as sensors 220 and 230 via direct communication links, a Wireless Local Area Network (WLAN), a Wide Area Network (WAN), wireless communication networks using radio waves, a cellular network, and/or a local wireless network (e.g., Bluetooth™ or WiFi), or other communication methods. In some embodiments, communication interface 402 can be an integrated services digital network (ISDN) card, cable modem, satellite modem, or a modem to provide a data communication connection. As another example, communication interface 402 can be a local area network (LAN) card to provide a data communication connection to a compatible LAN. Wireless links can also be implemented by communication interface 402. In such an implementation, communication interface 402 can send and receive electrical, electromagnetic or optical signals that carry digital data streams representing various types of information via a network.

Consistent with some embodiments, communication interface 402 may receive sensor data 401 acquired by sensors 220 and/or 230, as well as map data 403 provided by 3-D map database 240, and provide the received information to memory 406 and/or storage 408 for storage or to processor 404 for processing. Sensor data 401 may include information capturing various moving objects (such as vehicle 130, bicycle 140, and pedestrian 150) and other surrounding objects such as regulatory objects. Sensor data 401 may contain data captured over time that characterize the movements of the moving objects. In some embodiments, map data 403 may include point cloud data.

Communication interface 402 may also receive a learning model 405. In some embodiments, learning model 405 may be applied by processor 404 to jointly predict movement trajectories of the various moving objects based on features extracted from sensor data 401 and map data 403. In some embodiments, learning model 405 may be a predictive model, such as a decision tree learning model, a logistic regression model, a reinforced learning model, or a deep learning model such as a convolutional neural network (CNN). Other suitable machine learning models may also be used as learning model 405.

A decision tree uses observations of an item (represented in the branches) to predict a target value of the item (represented in the leaves). For example, a decision tree model may predict the probabilities of several hypothetical outcomes, e.g., probabilities of the candidate trajectories of a moving object. In some embodiments, gradient boosting may be combined with the decision tree learning model to form a prediction model as an ensemble of decision trees. For example, learning model 405 may become a Gradient Boosting Decision Tree model formed with stage-wise decision trees.

In some embodiments, learning model 405 may be a logistic regression model that predicts values of a discrete variable. For example, a logistic regression model may be used to rank several hypothetical outcomes, e.g., to rank the candidate trajectories of the moving objects. In some embodiments, learning model 405 may be deep learning model such as a convolutional neural network that includes multiple layers. The multiple layers may include one or more convolution layers or fully-convolutional layers, non-linear operator layers, pooling or subsampling layers, fully connected layers, and/or final loss layers. Each layer of the CNN model produces one or more feature maps. A CNN model is usually effective for tasks such as image recognition, video analysis, and image classification to, e.g., identify objects from image or video data.

In some embodiments, learning model 405 may be trained using known movement trajectories of moving objects and their respective sample features, including object features that characterize the moving objects and regulation features that specify the rules the moving objects have to obey. In some embodiments, object features may include semantic features such as the moving speed of each moving object, the orientation of each moving object (i.e., the direction the object is facing), the hand signals of the pedestrian or cyclist, the markings of the crosswalk, etc. The sample features may additionally include non-semantic features extracted from data descriptive of the moving objects. In some embodiments, regulation features may include traffic rules that specify right-of-way among the various moving objects, status of the traffic light and pedestrian traffic light, gesture of the police officer, etc. “Right-of-way” specifies the order that the various moving objects could occupy a certain section of the road. For example, when a pedestrian wants to cross on a crosswalk, other moving objects, such as vehicles and bicycles, have to yield. “Right-of-way” can be modified or otherwise defined by other regulatory objects, such as traffic lights and officers. For example, if a cross-road is regulated by pedestrian traffic light, the pedestrian facing a light that is in a “walk” mode has the right-of-way. When an officer is regulating the traffic under specially circumstances, such as when there is an accident or road block, he can redefine the right-of-way by signaling the moving objects with gestures.

In some embodiments, learning model 405 may be trained by server 210 or another computer/server ahead of time. As used herein, “training” a learning model refers to determining one or more parameters of at least one layer in the learning model. For example, a convolutional layer of a CNN model may include at least one filter or kernel. One or more parameters, such as kernel weights, size, shape, and structure, of the at least one filter may be determined by e.g., a backpropagation-based training process. Learning model 405 is trained such that when it takes the sample features as inputs, it will provide a combination of predicted movement trajectories for the various moving objects substantially close to their known trajectories.

Processor 404 may include any appropriate type of general-purpose or special-purpose microprocessor, digital signal processor, or microcontroller. Processor 404 may be configured as a separate processor module dedicated to jointly predicting movement trajectories of multiple moving objects. Alternatively, processor 404 may be configured as a shared processor module for performing other functions related to or unrelated to trajectory predictions. For example, the shared processor may further make autonomous driving decisions based on the predicted movement trajectories of the moving objects.

As shown in FIG. 4, processor 404 may include multiple modules, such as a positioning unit 440, an object identification unit 442, a feature extraction unit 444, a trajectory prediction unit 446, and the like. These modules (and any corresponding sub-modules or sub-units) can be hardware units (e.g., portions of an integrated circuit) of processor 404 designed for use with other components or to execute part of a program. The program may be stored on a computer-readable medium (e.g., memory 406 and/or storage 408), and when executed by processor 404, it may perform one or more functions. Although FIG. 4 shows units 440-446 all within one processor 404, it is contemplated that these units may be distributed among multiple processors located near or remotely with each other.

Positioning unit 440 may be configured to position the moving objects (e.g., vehicle 130, bicycle 140, pedestrian 150) whose trajectories are being predicted in map data 403. In some embodiments, sensor data 401 may contain various data captured of the moving objects to assist the positioning. For example, LiDAR data captured by sensor 340 mounted on vehicle 120 may reveal the positions of the moving objects in the point cloud data. In some embodiments, the point cloud data captured of the moving objects may be matched with map data 403 to determine their positions. In some embodiments, positioning methods such as simultaneous localization and mapping (SLAM) may be used to position the moving objects.

In some embodiments, the positions of the moving objects (e.g., vehicle 130, bicycle 140, pedestrian 150) may be labeled on map data 403. For example, a subset of point cloud data P₁ is labeled as corresponding to pedestrian 150 at time T₁, a subset of point cloud data P₂ is labeled as corresponding to pedestrian 150 at time T₂, and a subset of point cloud data P₃ is labeled as corresponding to pedestrian 150 at time T₃, etc. The labeled subsets indicate the existing moving trajectory and moving speed of the pedestrian.

Object identification unit 442 may identify the moving objects (e.g., vehicle 130, bicycle 140, pedestrian 150) and regulatory objects surrounding the pedestrian. These surrounding regulatory objects may include, e.g., traffic light 160, pedestrian traffic lights 162, crosswalk 170, officer 180, and other vehicles, etc. In some embodiments, various image processing methods, such as image segmentation, classification, and recognition methods, may be applied to identify the moving objects and the surrounding regulatory objects. In some embodiments, machine learning techniques, such as CNN models, may also be applied for the identification.

Feature extraction unit 444 may be configured to extract features from sensor data 401 and map data 403 that are indicative of a future trajectory of a pedestrian. The features extracted may include object features and regulation features. Object features may be associated with the moving objects (e.g., vehicle 130, bicycle 140, pedestrian 150), e.g., the speed of each moving object, the direction the moving object is facing, etc. Regulation features may be associated with the regulatory objects, such as the right-of-way, the orientation of the crosswalk, lane markings of sidewalk, the status of the traffic light, pedestrian traffic light, the pedestrian or cyclist hand signals, and the gesture of the police officer, etc.

Various feature extraction tools may be used, such as facial recognition, gesture detection, movement detection, gait recognition, etc. For example, feature extraction unit 444 may perform facial recognition to identify the pedestrian's face. The pedestrian's face provides important information where the pedestrian is heading to. As another example, feature extraction unit 444 may also perform gesture detection methods to detect pedestrian hand gestures or gestures of an officer. Pedestrian hand gestures may signal where the pedestrian intends to go.

In addition, lane markings and crosswalk markings can be detected from the sensor data based on color and/or contrast information as the markings are usually in white paint and road surface is usually black or gray in color. When color information is available, the markings can be identified based on their distinct color (e.g., white). When grayscale information is available, the markings can be identified based on their different shading (e.g., lighter gray) in contrast to the background (e.g., darker gray for regular road pavements). The orientation of a crosswalk can be determined based on the direction the stipe markings of the crosswalk are extending. As another example, traffic light signals can be detected by detecting the change (e.g., resulting from blinking, flashing, or color changing) in image pixel intensities. In some embodiments, machine learning techniques may also be applied to extract the feature(s).

Trajectory prediction unit 446 may jointly predict the movement trajectories of the various moving objects using the extracted object features and regulation features. In some embodiments, trajectory prediction unit 446 may determine a plurality of candidate trajectories for each moving object. For example, trajectory prediction unit 446 may determine candidate trajectories 131-134 for vehicle 130, candidate trajectories 141-144 for bicycle 140, candidate trajectories 151-154 for pedestrian 150 (shown in FIG. 2B).

In some embodiments, trajectory prediction unit 446 may apply learning model 405 for the joint prediction. For example, learning model 405 may determine a score for each candidate trajectory based on the extracted features. In some embodiments, the score may be indicative of a probability that the respective moving object follows the candidate trajectory. In some other embodiments, the score may be a ranking number assigned to the respective trajectory. In some embodiments, the combination of candidate trajectories of the moving objects with the highest combined score (e.g., highest collective probability or ranking) may be identified as the predicted movement trajectories of the moving objects.

In some embodiments, before applying learning model 405, trajectory prediction unit 446 may first determine one or more conflicting candidate trajectories based on the regulation features, and remove sets of candidate trajectories that include the conflicting candidate trajectories. For example, a combination of candidate trajectories 141 and 151 may be eliminated since that would have conflicted with the right-of-way between pedestrian 150 and bicycle 140. As another example, if pedestrian traffic light 162-A is in a “do not walk” mode, any combination of candidate trajectories that includes candidate trajectory 151 may be eliminated. By removing certain combinations of candidate trajectories, trajectory prediction unit 446 simplifies the prediction task and conserves processing power of processor 404.

In some embodiments, trajectory prediction unit 446 may compare the combined scores (e.g., probabilities) for different sets of predicted candidate trajectories with a threshold. If no combined a score exceeds the threshold, trajectory prediction unit 446 may determine that the prediction is not sufficiently reliable and additional “observations” are necessary to improve the prediction. In some embodiments, trajectory prediction unit 446 may determine what additional sensor data can be acquired and generate control signals to be transmitted to sensors 220 and/or 230 for capturing the additional data. For example, it may be determined that the LiDAR should be tilted at a different angle or that the camera should adjust its focal point. The control signal may be provided to sensors 220 and/or 230 via communication interface 402.

Memory 406 and storage 408 may include any appropriate type of mass storage provided to store any type of information that processor 404 may need to operate. Memory 406 and storage 408 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 406 and/or storage 408 may be configured to store one or more computer programs that may be executed by processor 404 to perform trajectory prediction functions disclosed herein. For example, memory 406 and/or storage 408 may be configured to store program(s) that may be executed by processor 404 to jointly predict the movement trajectories of the various moving objects based on object features and regulation features.

Memory 406 and/or storage 408 may be further configured to store information and data used by processor 404. For instance, memory 406 and/or storage 408 may be configured to store sensor data 401 captured by sensors 220 and/or 230, map data 403 received from 3-D map database 240, and learning model 405. Memory 406 and/or storage 408 may also be configured to store intermediate data generated by processor 404 during feature extraction and trajectory prediction, such as the object features and regulation features, the candidate trajectories, and the scores for the candidate trajectories and combined scores for sets of candidate trajectories. The various types of data may be stored permanently, removed periodically, or disregarded immediately after each frame of data is processed.

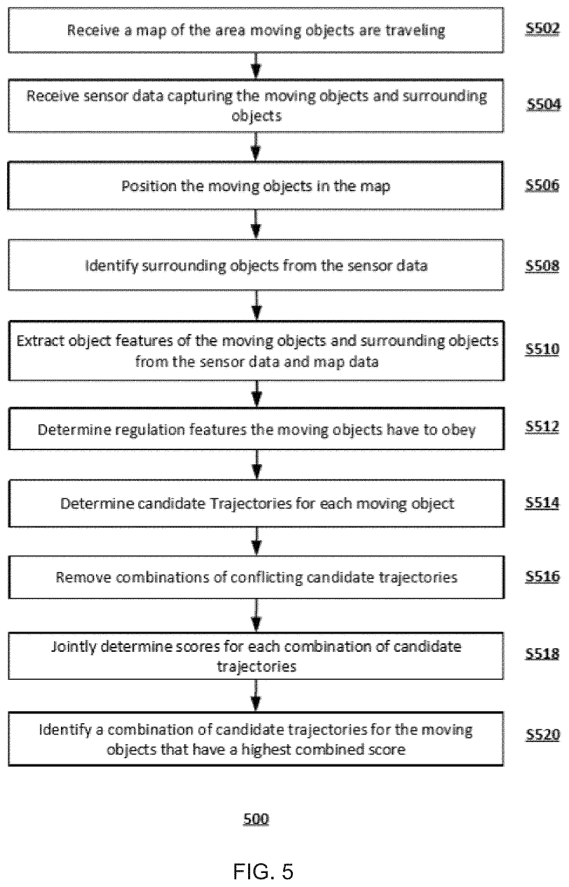

FIG. 5 illustrates a flowchart of an exemplary method 500 for jointly predicting movement trajectories of multiple moving objects, according to embodiments of the disclosure. For example, method 500 may be implemented by system 200 that includes, among other things, server 210 and sensors 220 and 230. However, method 500 is not limited to that exemplary embodiment. Method 500 may include steps S502-S522 as described below. It is to be appreciated that some of the steps may be optional to perform the disclosure provided herein. Further, some of the steps may be performed simultaneously, or in a different order than shown in FIG. 5. For description purpose, method 500 will be described as joint predicting a combination of movement trajectories of various moving objects to aid autonomous driving decisions of vehicle 120 (as shown in FIG. 1). Method 500, however, can be implemented for other applications that can benefit from accurate predictions of movement trajectories.

In step S502, server 210 receives a map of the area the moving objects (e.g., vehicle 130, bicycle 140, pedestrian 150) are traveling. In some embodiments, server 210 may determine the position of vehicle 120 based on, e.g., the GPS data collected by sensor 360, and identify a map area surrounding the position. For example, the map may be a map of cross-road 100. Server 210 may receive the relevant 3-D map data, e.g., map data 403, from 3-D map database 240.

In step S504, server 210 receives the sensor data capturing the moving objects (e.g., vehicle 130, bicycle 140, pedestrian 150) and surrounding objects (e.g., traffic light 160, pedestrian traffic light 162, crosswalk 170, and officer 180). In some embodiments, the sensor data may be captured by various sensors such as sensors 220 installed along the roads and/or sensors 230 (including, e.g., sensors 340-360) equipped on vehicle 120. The sensor data may include pedestrian speed acquired by a speedometer, images (including video images) acquired by cameras, point cloud data acquired by a LiDAR, etc. In some embodiments, the sensor data may be captured over time to track the movement of the moving objects and surrounding objects. The sensors may communicate with server 210 via a network to transmit the sensor data, e.g., sensor data 401, continuously, or regularly, or intermittently.

Method 500 proceeds to step S506, where server 210 positions the moving objects (e.g., vehicle 130, bicycle 140, pedestrian 150) in the map. In some embodiments, the point cloud data captured of the moving objects, e.g., by sensor 340, may be matched with map data 403 to determine their positions in the map. In some embodiments, positioning methods such as SLAM may be used to position the moving objects. In some embodiments, the positions of the moving objects at different time points may be labeled on map data 403 to trace their prior trajectories and moving speeds. Labeling of the point cloud data may be performed by server 210 automatically or with human assistance.

In step S508, server 210 identifies other objects surrounding the moving objects. In some embodiments, the surrounding objects include regulatory objects that regulate the traffic of moving objects. For example, these objects may include, e.g., traffic light 160, pedestrian traffic lights 162, crosswalk 170, officer 180, traffic signs, and lane markings, etc. Features of the surrounding objects may provide information useful for predicting the movement trajectories of the moving objects. In some embodiments, various image processing methods and machine learning methods (e.g., CNN) may be implemented to identify the surrounding objects.

In step S510, server 210 extracts object features of the moving objects and the surrounding objects from sensor data 401 and map data 403. In some embodiments, the object features extracted may include semantical or non-semantical features that are indicative of the future trajectories of the moving objects. For example, object features may include, e.g., the traveling speed of each moving object, and the direction the moving object is facing, any hand signals of the pedestrian or cyclist, etc. In some embodiments, various feature extraction methods including image processing methods and machine learning methods may be implemented.

In step S512, server 210 determines regulation features, which the moving objects have to obey. Regulation features may be associated with the regulatory objects, such as the right-of-way, the orientation of the crosswalk, lane markings of sidewalk, the statuses of the traffic light and pedestrian traffic light, the pedestrian or cyclist hand signals, and the gesture of the police officer, etc. Similarly, various feature extraction methods including image processing methods and machine learning methods may be implemented.

In step S516, server 210 may determine several candidate trajectories for each moving object. In the example of FIG. 2B, candidate trajectories 131-134 may be determined for vehicle 130, corresponding to vehicle 130 making a right-turn, going straight, making a left-turn, and making a U-turn, respectively. Candidate trajectories 141-144 may be determined for bicycle 140 traveling east-bound, corresponding to bicycle 140 going straight, turning left, turning around to travel west-bound, and making a stop, respectively. Candidate trajectories 151-154 may be determined for pedestrian 150 facing north, corresponding to crossing the road north-bound, turning left to go west-bound, turn righting to go east-bound, and making a stop, respectively.

In step S518, server 210 may remove combinations of candidate trajectories that include conflicting candidate trajectories. A combination of candidate trajectories include a candidate trajectory for each moving object. For example, candidate trajectories 131, 141, and 151 of vehicle 130, bicycle 140, and pedestrian 150, respectively, may form a “combination.” Theoretically, if m moving objects have N₁, N₂, . . . Nₘ candidate trajectories respectively, there can be as many as N₁×N₂× . . . xNₘ potential combinations. Applying machine learning to all these potential combinations can be computationally intensive.

In some embodiments, server 210 may first determine conflicting candidate trajectories based on the regulation features. Then the combinations of candidate trajectories that include the conflicting candidate trajectories may be removed from further consideration. For example, candidate trajectories 141 and 151 may be determined as conflicting candidate trajectories because the right-of-way requires bicycle 140 to yield pedestrian 150. Accordingly, any combination of candidate trajectories that simultaneously include candidate trajectories 141 and 151 may be removed. As another example, if pedestrian traffic light 162-A is in a “do not walk” mode, any combination of candidate trajectories that includes candidate trajectory 151 may be removed. Similarly, officer 180 may regulate the traffic by directing the moving objects to move only in certain way and prohibiting the others. For example, officer 180 may use gesture to direct vehicle 130 to only go straight or turn right, but not turn left or U-turn. Accordingly, any combination that include candidate trajectory 133 or 134 may be removed.

Method 500 proceeds to step S518 to jointly determine scores for each combination of candidate trajectories of the moving objects. For example, server 210 may determine a set of scores (S1, S2, S3) for a combination of candidate trajectories 131, 141, and 151 for the three moving objects: vehicle 130, bicycle 140, and pedestrian 150. In some embodiments, the score may be a probability the moving object will follow the corresponding candidate trajectory or a ranking number assigned to the candidate trajectory. In some embodiments, server 210 may apply learning model 405 to jointly predict the set of scores for each combination. In some embodiments, learning model 405 may be a predictive model, such as a decision tree learning model, a logistic regression model, or a deep learning model. For example, learning model 405 may be a Gradient Boosting Decision Tree model. In some embodiments, learning model 405 may be trained using known movement trajectories and their respective sample features.

For example, in step S518, learning model 405 may be applied to determine a set of probabilities for the candidate trajectory in each combination based on the extracted object features and regulation features. For example, in the combination of candidate trajectories 131, 141, and 151, it may be determined that vehicle 130 has a 80% probability to follow candidate trajectory 131, bicycle has 20% probability to follow candidate trajectory 141, and pedestrian 150 has a 60% probability to follow candidate trajectory 151.

In some embodiments, server 210 may determine a combined score of the individual scores for a combination. For example, the combined score may be S=S1+S2+S3. It is contemplated that the combined score can be determined using different mathematical formula rather than just an arithmetic addition. In some alternative embodiments, instead of determining individual scores for the candidate trajectories in a combination, server 210 may directly determine one score for the combination using learning model 405. For example, the score may indicate the overall probability the combination of candidate trajectories may be followed by the moving objects.

In step S520, server 210 may identify a combination of movement trajectories that has the highest combined or overall score. For example, combination of candidate trajectories 131, 142, and 154 may be selected as the predicted trajectories of the moving objects when the combination has the highest combined probability. In some other embodiments, when in step S518 sever 210 ranks the candidate trajectories rather than calculating the probabilities, method 500 may select the combination with the highest combined rankings in step S520.

The prediction result provided by method 500 may be provided to vehicle 120, and used to aid vehicle controls or driver's driving decisions. For example, an autonomous vehicle may make automated control decisions based on the predicted trajectories of the moving objects in order not to run over them. The prediction may also be used to help alert a driver to adjust his intended driving path and/or speed to avoid an accident. For example, audio alerts such as beeping may be provided to warn the driver and/or the cyclists and pedestrians.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for jointly predicting movement trajectories of a plurality of moving objects, comprising:
a communication interface configured to receive a map of an area in which the plurality of moving objects are traveling and sensor data acquired associated with the plurality of moving objects; and
at least one processor configured to:
position the plurality of moving objects in the map;
determine object features of each moving object based on the sensor data, the object features characterizing movement of the respective moving object;
determine regulation features of the moving objects, the regulation features characterizing traffic regulations the moving objects need to obey; and
jointly predict the movement trajectories of the plurality of moving objects based on the object features and regulation features using a learning model.

2. The system of claim 1, wherein to jointly predict the trajectories of the plurality of moving objects, the at least one processor is further configured to:
determine a plurality of candidate trajectories for each moving object;
determine a score for each candidate trajectory based on the object features and regulation features using the learning model; and
identify the predicted movement trajectories of the plurality of moving objects based on the scores.

3. The system of claim 2, wherein the at least one processor is further configured to:
determine conflicting candidate trajectories based on the regulation features; and
remove sets of candidate trajectories that include the conflicting candidate trajectories.

4. The system of claim 2, wherein the score is a probability the moving object will follow the corresponding candidate trajectory.

5. The system of claim 2, wherein the at least one processor is further configured to identify candidate trajectories of the respective moving objects with a highest combined score as the predicted movement trajectories of the moving objects.

6. The system of claim 1, wherein the learning model is a decision tree model, a logistic regression model, a reinforcement learning model, or a deep learning model.

7. The system of claim 1, wherein the sensor data includes point cloud data acquired by a LiDAR and images acquired by a camera.

8. The system of claim 1, wherein the plurality of moving objects are selected from the group of vehicles, bicycles, and pedestrians.

9. The system of claim 1, wherein the regulation features include traffic rules specifying right-of-way among the plurality of moving objects.

10. The system of claim 1, wherein the regulation features include statuses of traffic lights regulating the respective moving objects.

11. The system of claim 1, wherein to extract object features, the at least one processor is further configured to extract a prior movement trajectory of each moving object.

12. The system of claim 1, wherein the sensor data are acquired by at least one sensor equipped on a vehicle traveling in the area that the moving objects are traveling in, wherein the communication interface is further configured to provide the predicted movement trajectories of the moving objects to the vehicle.

13. A method for jointly predicting movement trajectories of a plurality of moving objects, comprising:
receiving, through a communication interface, a map of an area in which the plurality of moving objects are traveling and sensor data acquired associated with the plurality of moving objects;
positioning, by at least one processor, the plurality of moving objects in the map;
determining, by the at least one processor, object features of each moving object based on the sensor data, the object features characterizing movement of the respective moving object;
determining, by the at least one processor, regulation features of the moving objects, the regulation features characterizing traffic regulations the moving objects need to obey; and
jointly predicting, by the at least one processor, the movement trajectories of the plurality of moving objects based on the object features and regulation features using a learning model.

14. The method of claim 13, wherein jointly predicting the trajectories of the plurality of moving objects further comprising:
determining a plurality of candidate trajectories for each moving object;
determining a score for each candidate trajectory based on the object features and regulation features using the learning model; and
identifying the predicted movement trajectories of the plurality of moving objects based on the scores.

15. The method of claim 14, further comprising:
determining conflicting candidate trajectories based on the regulation features; and
removing sets of candidate trajectories that include the conflicting candidate trajectories.

16. The method of claim 14, wherein identifying the trajectories further comprises identifying candidate trajectories of respective moving objects with a highest combined score as the predicted movement trajectories of the moving objects.

17. The method of claim 13, wherein the learning model is a decision tree model, a logistic regression model, a reinforcement learning model, or a deep learning model.

18. The method of claim 13, wherein the regulation features include traffic rules specifying right-of-way among the plurality of moving objects, and statuses of traffic lights regulating the respective moving objects.

19. The method of claim 13, wherein the sensor data are acquired by at least one sensor equipped on a vehicle traveling in the area that the moving objects are traveling in, wherein the method further comprises providing the predicted movement trajectories of the moving objects to the vehicle.

20. A non-transitory computer-readable medium having instructions stored thereon that, when executed by at least one processor, causes the at least one processor to perform operations comprising:
receiving a map of an area in which a plurality of moving objects are traveling and sensor data acquired associated with the plurality of moving objects;
positioning the plurality of moving objects in the map;
determining object features of each moving object based on the sensor data, the object features characterizing movement of the respective moving object;
determining regulation features of the moving objects, the regulation features characterizing traffic regulations the moving objects need to obey; and
jointly predicting movement trajectories of the plurality of moving objects based on the object features and regulation features using a learning model.
